(19) United States
(12) Patent Application Publication
(10) Pub. No.: US 2008/0135190 A1
(43) Pub. Date: Jun. 12, 2008

(54) Window covering cutting aid

(76) Inventor: Li-Ming Cheng, Kaohsiung City (TW)

Correspondence Address: Joe McKinney Muncy, PO Box 1364, Fairfax, VA, 22038-1364, US

(21) Appl. No.: 11/636,525

(22) Filed: Dec. 11, 2006

(51) Int. Cl. E06B 9/266; B26D 7/01

(52) U.S. Cl. 160/178.1 R; 33/194

(57) ABSTRACT

An improved window covering cutting aid includes a hollow sleeve consisting of a front wall, a rear wall, a top wall, a bottom wall and a spacer located at the bottom of the sleeve bridging the front wall and the rear wall. The sleeve has a cutting slot vertical to the bottom wall and running through the top wall, front wall, rear wall and another slot formed on the spacer close to the bottom wall. The surfaces of the front and rear walls have respectively a dimensional scale corresponding to the cutting slot. A retracted window covering can be held in the window covering cutting aid with a slat assembly resting on the spacer that has an adhesive tape attached to the bottom end thereof. A cutting tool can be placed in the cutting slot to finish cutting operation of the slat assembly and window covering by one pass.

### FIELD OF THE INVENTION

The present invention relates to an improved window covering cutting aid and particularly to a cutting aid that encases a window covering to allow a slat assembly to be retracted and rested on a spacer and enable a cutting tool to be moved vertically downwards to cut off the window covering.

### BACKGROUND OF THE INVENTION

A great number of window coverings now on the market such as Venetian blinds, pleated window coverings and the like are installed by users after purchase. During installation on the door or window, if the width of the window covering is greater than that of the door or window, the window covering has to be cut to a desired width.

FIG. 1 shows a blind which serves as an example. The window covering 1 has an upper rail 11, a lower rail 12 spaced from the upper rail 11, a retractable slat assembly 13 located between the upper rail 11 and the lower rail 12, and a lift cord control means 14 to control upward retraction or downward extension of the slat assembly 13. During installation of the window covering 1, if the width of the upper and lower rails 11 and 12 and the slat assembly 13 is greater than the width of the door or window, the slat assembly 13 may be retracted as shown in FIG. 2, then the length (.) of the extra portion on one side of the window covering 1 is cut off by means of a cutting tool such as a saw to make the total width of the window covering 1 to match the width of the door or window.

The cutting process mentioned above does not use any aid to guide the cutting tool. As a result, the cut window covering 1 tends to form a skew side edge as shown in FIG. 2. It spoils the total aesthetic profile of the window covering 1. The interior decoration of the house also is affected. To remedy this problem, various types of window covering cutting aids have been developed.

U.S. Pat. No. 6,865,817 discloses a window covering cutting aid with a measurement guide. It mainly includes a hollow body with two ends communicating with each other. The body has a cutting slot extended downwards from the top side for a selected distance. When in use, a ruler sticker with a length scale is attached to a upper side of the window covering; then the window covering is retracted and held in the hollow body; finally according to the scale on the ruler sticker, a cutting tool is placed in the cutting slot to cut the widow window covering vertically downwards along the cutting slot. The resulting window covering has a vertical and neater edge. While the window covering cutting aid mentioned above can facilitate cutting operation, it still has problems in practice, notably:

1. Using the cutting tool to cut the window covering along the cutting slot also cuts off the window covering cutting aid. Thus the window covering cutting aid cannot be reused. It is a waste of resources.

2. The slat assembly has a non-bonding portion on one side relative to the lower rail that is attached to an adhesive tape covered by a releasing sheet. When the slat assembly is retracted and held in the window covering cutting aid, and cut by the cutting tool through the cutting slot, the tough adhesive tape cannot be cut off easily. Moreover, when the cutting tool reaches the distal end of the cutting slot, cutting operation has to be stopped, and the window covering cutting aid has to be removed from the window covering to cut off the remained portion. Hence cutting operation cannot be finished by one pass. It is not convenient.

3. Before the window covering cutting aid is used, a ruler sticker with a length scale has to be bonded to the upper side of the window covering to be cut to facilitate measuring of the length of the cutting portion. This procedure incurs additional and troublesome preparations.

4. The cutting slot has a bottom end spaced from the bottom of the window covering cutting aid at a selected distance. Hence after the cutting tool reaches the bottom end of the cutting slot, to cut off the remained portion of the window covering is unguided. The side edge of the window covering could still be skewed. Hence its practicality is not desirable.

### SUMMARY OF THE INVENTION

Therefore the primary object of the present invention is to provide a window covering cutting aid to overcome the problems of the conventional window covering cutting aids such as not able to be used repetitively, inconvenient, not able to finish cutting by one process, not practical measuring means and the like. The invention aims to provide a smoother cutting operation for window coverings.

To achieve the foregoing object, the window covering cutting aid of the invention mainly includes a hollow sleeve consisting of a front wall, a rear wall, a top wall and a bottom wall, and a spacer bridging the front wall and the rear wall close to the bottom. The hollow sleeve has a cutting slot on one side vertical to the bottom wall. The cutting slot is extended vertically from the top wall, front wall and rear wall, runs through another slot of the spacer and is extended towards the bottom wall at a selected distance. The surfaces of the front and rear walls have a dimensional scale corresponding to the cutting slot.

The window covering cutting aid thus formed can achieve the following effects:

1. Cutting of the window covering is more convenient: The slat assembly which has the adhesive tape on the bottom can be rested on the spacer. With the aid of the cutting slot which runs through the spacer and is spaced from the bottom wall, the slat assembly, including the adhesive tape, can be cut off by one pass through the vertically moving cutting tool.

2. Provide length measuring function: Before cutting the window covering, the dimension of the cut off portion can be measured through the dimensional scale to prevent the length of the cut window covering from unfitting to the width of the door or window.

3. Usable repetitively: The cutting operation is finished when the cutting tool cuts off the adhesive tape at the bottom of the slat assembly. Then the cut window covering can be removed, and the window covering cutting aid can be reused repetitively.

4. The cut window covering has a neat and vertical side edge: As the cutting slot is vertical to the bottom wall, it provides an excellent guiding effect for the cutting tool and can prevent skewing of the side edge of the window covering after the cutting operation is finished.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional window covering.

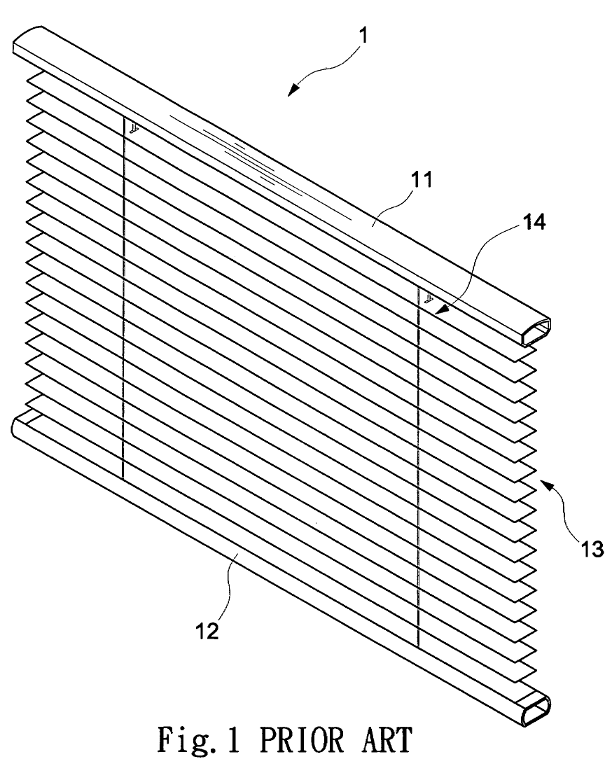

FIG. 2 is a front view of a conventional window covering after cutting.

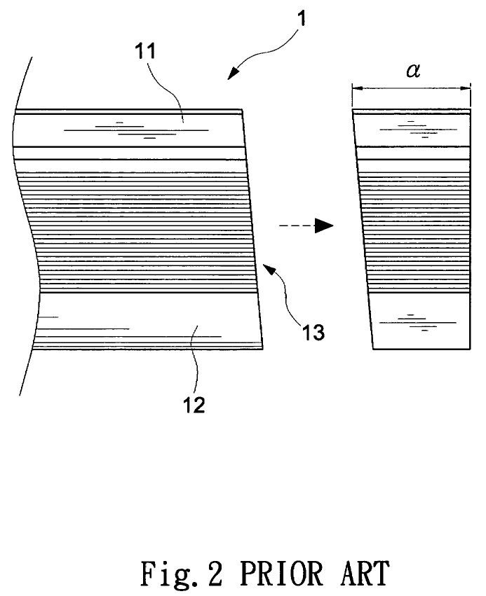

FIG. 3 is a perspective view of the window covering cutting aid of the present invention.

FIG. 4 is a schematic view of the window covering cutting aid of the present invention in operating condition-1.

FIG. 5 is a schematic view of the window covering cutting aid of the present invention in operating condition-2.

FIG. 6 is a schematic view of the window covering cutting aid of the present invention in operating condition-3.

FIG. 7 is a schematic view of the window covering cutting aid of the present invention in operating condition-4.

### DETAILED DESCRIPTION OF THE PREFERRED EMBODIMENTS

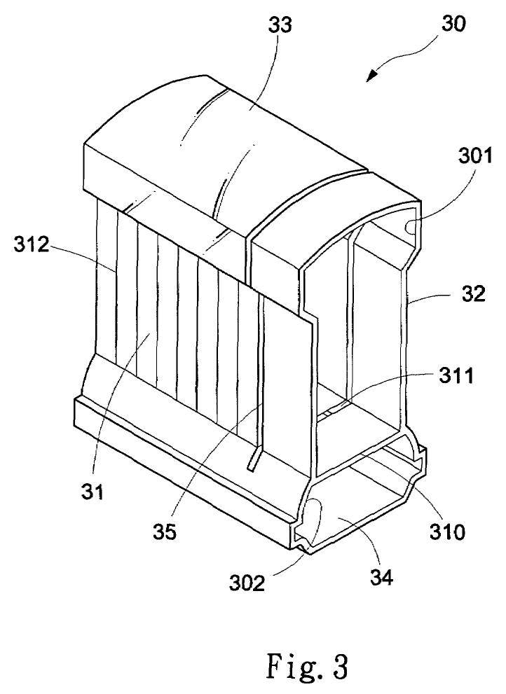

Please refer to FIG. 3, the window covering cutting aid according to the invention includes a hollow sleeve 30 consisting of a front wall 31, a rear wall 32, a top wall 33, a bottom wall 34, and a spacer 310 bridging the front wall 31 and the rear wall 32 close to the bottom. The sleeve 30 has a cutting slot 35 on one side vertical to the bottom wall 34 that runs through the top wall 33, front wall 31, rear wall 32 and another slot 311 formed on the spacer 310 and close to the bottom wall 34. The spacer 310 is integrally formed with the front wall 31 and rear wall 32.

The hollow sleeve 30 is formed in various shapes to mate different profiles of window shapes on the market (the profiles are geometric shapes of the window covering after retraction). FIG. 3 shows an example in which the hollow sleeve 30 has an expanded first holding portion 301 adjacent to the top wall 33 and an expanded second holding portion 302 adjacent to the bottom wall 34 to hold a window covering which has a larger upper rail and a larger lower rail.

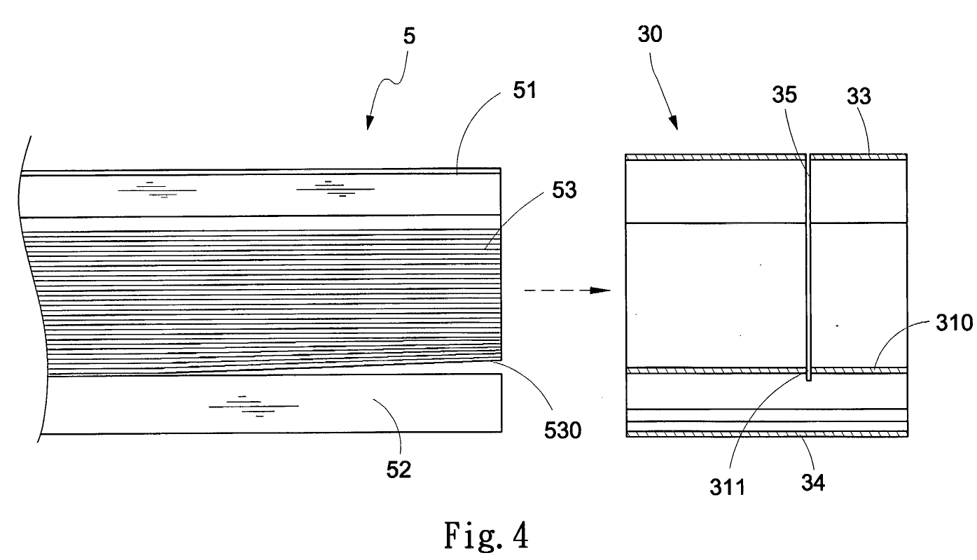

The surfaces of the front wall 31 and rear wall 32 have a dimensional scale 312 corresponding to the cutting slot 35. Referring to FIG. 4, the invention mainly aims to facilitate cutting of a window covering 5 that has an upper rail 51, a lower rail 52 and a slat assembly 53 which has an adhesive tape 530 attached to the bottom, such as Venetian blinds, pleated window coverings or the like. Details of use conditions are discussed below:

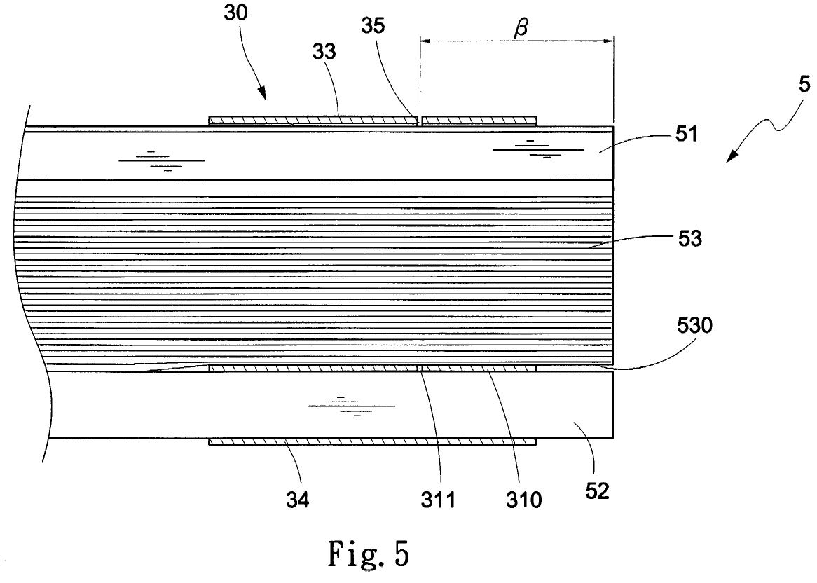

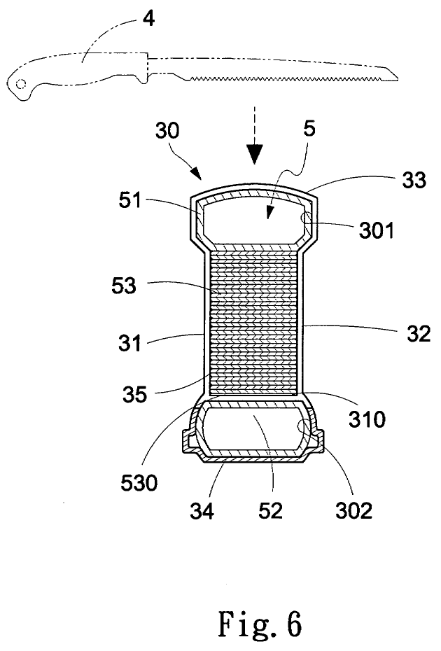

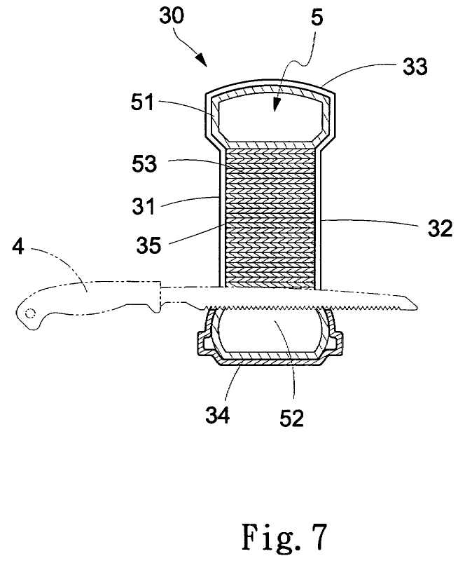

Referring to FIGS. 3, 4 and 5, first, the slat assembly 53 of the window covering 5 to be cut is retracted; next, encase the window covering 5 in the sleeve 30; rest the slat assembly 53 with the adhesive tape 530 on the bottom on the spacer 310, with the upper rail 51 held in the first holding portion 301 and the lower rail 52 held in the second holding portion 302; measure the length (.) on one side of the window covering 5 to be cut off through the dimensional scale 312 on the surfaces of the front wall 31 and rear wall 32; then as shown in FIGS. 6 and 7, place a cutting tool 4 such as a saw or the like in the cutting slot 35 with one hand holding the top wall 33 of the sleeve 30 and other hand grasping the cutting tool 4; slit the upper rail 51, slat assembly 53 with the adhesive tape 530 on the bottom and lower rail 52 in this order from up to down until the cutting tool 4 reaches the bottom end of the cutting slot 35 to finish the cutting operation of the window covering 5. Such an approach gives the cutting tool 4 an excellent guide for downward cutting operation. The slat assembly 53 resting on the spacer 310 with the adhesive tape 530 on the bottom can be cut off easily. The cut window covering 5 has a neater and smoother side edge and skewing is less likely to occur. Thus the entire window covering 5 is more appealing. The width of the cut window covering 5 also can fit the width of the door or window accurately.

In short, the window covering cutting aid of the invention can finish cutting operation of the window covering 5 and slat assembly 53 with the adhesive tape 530 attached to the bottom by one pass. The length of the cut window covering 5 can fit the width of the door or window precisely, and the side edge is vertical and neater. It also can be used repeatedly. It greatly enhances the convenience of cutting operation of the window covering 5.

What is claimed is:

1. An improved window covering cutting aid comprising a hollow sleeve which includes a front wall, a rear wall, a top wall, a bottom wall and a spacer located at the bottom of the sleeve bridging the front wall and the rear wall to hold a slat assembly which has an adhesive tape attached to the bottom thereof, the sleeve having a cutting slot on one side vertical to the bottom wall, the cutting slot running through the top wall, the front wall, the rear wall and another slot formed on the spacer close to the bottom wall.

2. The improved window covering cutting aid of claim 1, wherein the hollow sleeve has an expanded first holding portion adjacent to the top wall and an expanded second holding portion adjacent to the bottom wall.

3. The improved window covering cutting aid of claim 1, wherein the front wall and the rear wall of the hollow sleeve have respectively a dimensional scale.
